(19) United States
(12) Patent Application Publication
(10) Pub. No.: US 2003/0110403 A1
(43) Pub. Date: Jun. 12, 2003

(54) System for shared power supply in computer peripheral devices

(75) Inventors: Randolph E. Crutchfield, Scottsdale, AZ (US); James B. White, Phoenix, AZ (US)

Correspondence Address: MARGER JOHNSON & McCOLLOM, P.C., 1030 S.W. Morrison Street, Portland, OR, 97205, US

(73) Assignee: Intel Corporation, Santa Clara, CA

(21) Appl. No.: 10/016,254

(22) Filed: Dec. 10, 2001

(51) Int. Cl. G06F 1/26

(52) U.S. Cl. 713/300

(57) ABSTRACT

A power sharing circuit in a peripheral device that can combine power from both an external power supply and from an internal power supply is disclosed. The external power supply could be a computer bus, for example. The power sharing circuit has power inputs from both the computer bus and from the internal power supply, and has an output that powers the load circuitry in the peripheral device. The power sharing circuit monitors power used by the load circuitry and determines from where the power that drives the load circuitry will originate. The power can originate from either the internal or external power supply, or from a combination of the power supplies. The power sharing circuit can modify the origin of power provided to the load circuitry based on how much power it is using.

### TECHNICAL FIELD

This disclosure relates to providing power to computer peripheral devices, and, more particularly, to a system for sharing power requirements of a peripheral device between power supplied by a computer interface and power supplied by the device itself.

### BACKGROUND

Devices peripheral to personal computers are used for a variety of input or output purposes. Computer input devices include keyboards, mice, drawing tablets, cameras, etc., while computer output devices include speakers, printers, monitors, etc. Almost without exception, peripheral devices require a power source for proper operation.

Oftentimes peripheral devices are powered completely by a cable coupling the peripheral device to the computer, such as standard connection cables for using a variety of busses and communication protocols including, for example: Universal Serial Bus (USB, developed by the USB Implementers Forum, Inc.), PS/2 (International Business Machine's Personal System 2), RS232 (now renamed to EIA232 of the Electronic Industries Association), FireWire (Institute of Electrical and Electronics Engineers, Inc.'s 1394-1995 standard), Apple Computer Inc.'s Apple Desktop Bus (ADB), etc., and their successors. These cables typically provide a 5-volt or some other direct current (de) signal at a given current capacity to power the peripheral device. The USB specifications, for instance, state any device that draws less than 100 mA of power from the bus is a “low power” device, and a “high power” device draws between 100 mA and 500 mA. No single peripheral device is allowed to draw more than 500 mA of current from the USB bus.

FIG. 1A shows a peripheral device 10 that is powered by a computer bus 20, which is integral with a computer 18. The peripheral 10 includes internal load circuitry 12, which consumes the power in the peripheral. The load circuitry 12 is specific to the particular type of peripheral to which it belongs. For instance, if the peripheral 10 is a computer mouse, the load circuitry 12 would include X-Y positional circuits, mouse-click circuits, and data transfer circuits, etc. The peripheral 10 also includes a power interface 16 that converts power received from a computer bus 20 to power that can be used by the load circuitry 12. For instance, power supplied by the computer bus 20 may be a 5 volt dc voltage, whereas the load circuitry 12 may run on 3 volts or other voltage. In this case, the power interface 16 would include voltage converting circuitry. Also, if the load circuitry 12 needs an alternating current (ac) signal, the power interface 16 would contain the appropriate circuits to convert the input power signal from the computer bus 20 into the desired output signal needed by the attached load circuitry, for instance by using an internal oscillator or other type of circuit.

The peripheral 10 connects to the computer bus 20 via a bus cable 22. The bus cable 22 has internal wires to transfer data signals, and has wires to transfer power from the computer 18 to the peripheral devices to which it is connected. The cable 22 may run directly from the computer 18 to the peripheral 10, or may first plug into a bus hub 24. Hubs 24 are used to expand the physical number of ports on the computer bus 20 that peripheral devices can plug in to. For instance, there may be four “down” sockets 26 and one “up” socket 28 in a hub 24. Peripheral devices plug into the down sockets 26, while the up socket 28 connects to the computer 18. Hubs 24 can be plugged into one another to make even more sockets 26 available to peripheral devices, but, depending on the particular type of computer bus 20 that the devices are plugged in to (USB, FireWire, etc.) there is a limit to the number of peripheral devices that can be simultaneously connected to the bus. Also, hubs 24 can be self-powered i.e., have a power socket that plugs into a wall socket or wall transformer, or can be powered directly from the computer bus 20 itself, via the cable 22. In either case, a power controller on the computer bus 20 manages where the power is supplied to the bus itself.

The peripheral 10 of FIG. 1A is fully powered by the computer bus 20, the power being carried by the power wires in the bus cable 22.

Conversely, a peripheral 30, shown in FIG. 1B, receives no power from the computer bus 20, and instead includes its own power supply 36 to power its load circuitry 32. The power supply 36 could be internal batteries, or could be power supplied from another (non-bus) source, such as from a wall socket or transformer. Data to and from the peripheral 30 is still received from/transmitted to the computer 18 via the bus cable 22, but the power lines within the bus cable 22 are not used to supply power to the peripheral 30.

FIG. 1C shows a hybrid peripheral 40, which uses power either from a power interface circuit 44 that is coupled to the computer bus 20, or power from an internal power supply 46 to drive its load circuitry 42, depending on whether the peripheral 40 is connected to the computer bus 20. When the peripheral 40 is connected to the computer bus 20, all of the power necessary for the load circuitry 42 comes from the computer bus 20. When the peripheral 40 is disconnected from the cable 22, the internal power supply 46 supplies all of the power to the load circuitry 42. An example of a type of hybrid peripheral 40 is an MP3 (Moving Picture Experts Group—Level 3) player. Types of MP3 players use power from the computer bus 20 when they are connected to the bus cable 22; for instance, when they are downloading music files. After disconnecting from the bus cable 22, however, the MP3 player would rely solely on its internal power supply 46. A digital camera can have similar functions, where it is self powered by batteries, then uses bus power when it is transferring its images to a computer over a computer bus.

All three of the above-described peripherals 10, 30 and 40 suffer from problems with their power supplies. Peripherals such as 10, which are solely powered by the computer bus 20, are limited to how much current they can draw from the bus, based on the specifications of the bus. Also, the peripherals 10 and 40 may require complex power circuitry 16 to manage their power draw. For instance, the USB specification requires that all peripheral devices must draw less than 100 mA while seeking permission to connect to the computer bus 20 as a high power device. Only once permission is given can they raise their current drawing level up to 500 mA. Self-powered peripherals, such as the peripheral 30, do not have the complexities of trying to negotiate power with the computer bus 20, but are either wasteful by consuming batteries unnecessarily, or are inconvenient by the physical requirements of supplying power to the device (requiring a power cord, having an available wall plug, etc). The peripheral 40, which uses two types of power circuits 44, 46 (one internal and the other from the bus), is a good compromise, but having two full sets of power circuits is redundant and expensive.

Embodiments of the invention address these and other deficiencies in the prior art.

### BRIEF DESCRIPTION OF THE DRAWINGS

The description may be best understood by reading the disclosure with reference to the drawings, wherein:

FIG. 1A is a block diagram showing a peripheral device that is powered solely by a computer bus.

FIG. 1B is a block diagram showing a peripheral device that is solely self powered.

FIG. 1C is a block diagram showing a peripheral device that is powered either solely by a computer bus or solely by itself.

FIG. 2 is a block diagram showing a power sharing circuit in a peripheral device according to an embodiment of the invention.

FIG. 3 is a circuit diagram showing details of a circuit for sharing power according to an embodiment of the invention.

FIG. 4 is a circuit diagram showing additional detail of a portion of the circuit shown in FIG. 3.

FIG. 5 is a circuit diagram showing details of a circuit for sharing power according to another embodiment of the invention.

FIG. 6 is a graph showing power sharing according to embodiments of the invention.

FIG. 7 is a block diagram showing details of a circuit for sharing power according to another embodiment of the invention.

FIG. 8 is a flowchart showing steps that can be used to implement a power switching device.

### DETAILED DESCRIPTION

Embodiments of the invention include a power sharing circuit within a peripheral device that can combine power from both a computer bus as well as from an internal power supply to run load circuits within the peripheral device. The power sharing circuit has power inputs from both the computer bus and from the internal power supply, and has an output that powers the load circuitry in the peripheral device. In one embodiment, the power sharing circuit uses as much power as possible from the computer bus, up to a limit, then supplements any power needs of the device that are above that limit with the device's own power supply. If the computer bus has multiple power operating limits, the power sharing circuit can be configured to operate at either or both of the limits.

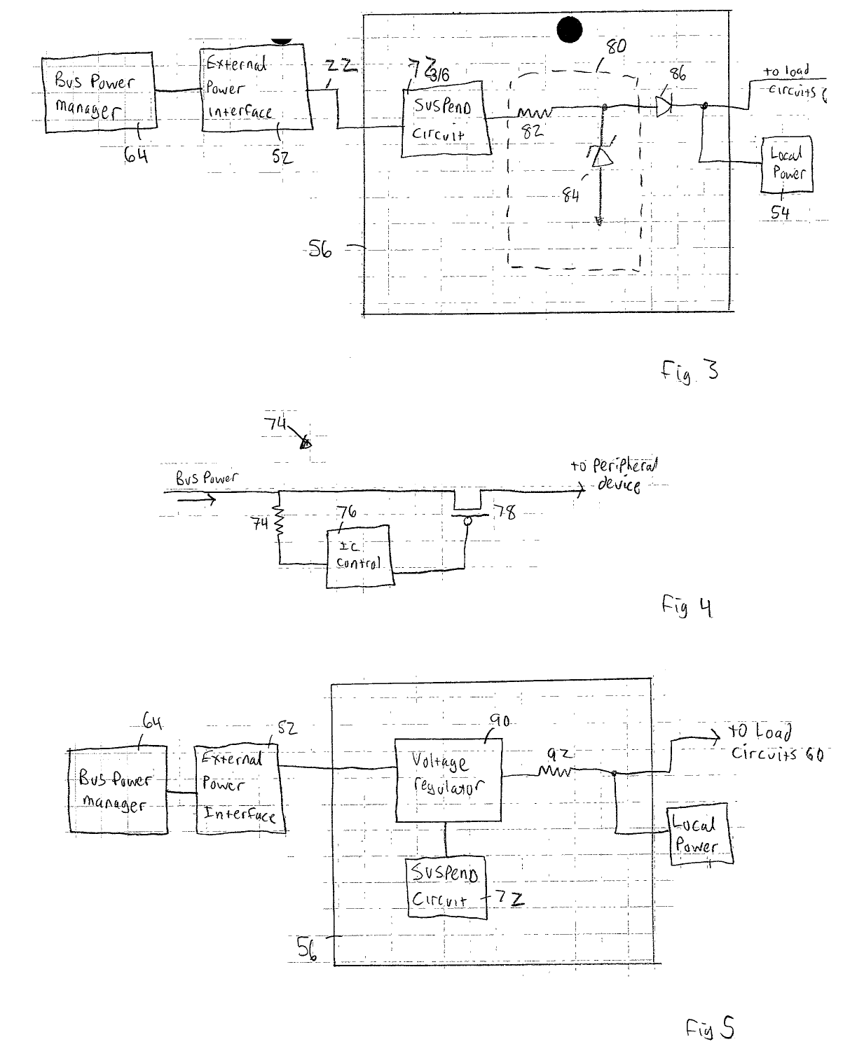

FIG. 2 is a block diagram showing an embodiment of the invention. A peripheral device 50 is connected to a computer bus 20 through a bus cable 22. The computer bus 20, in turn, receives its power from a computer 18. In the peripheral 50, power signals from the bus cable 22 are directed to an external power interface 52, which may also include protection or other circuits, such as for protecting the peripheral 50 from damage by electrostatic discharge, for instance.

The peripheral 50 also includes an internal local power supply 54. The local power supply 54 may be a battery supply, a circuit coupled to an external supply, (but other than the computer bus 20) such as an external transformer, or could even be a transformer itself.

Power signals from the external power interface 52 and from the local power supply 54 are both routed to a power sharing circuit 56. The power sharing circuit 56 has an output that drives load circuitry 60 of the peripheral 50. As described above, the specific circuitry that makes up the load circuitry 60 will be determined by what type of device the peripheral 50 is.

When the peripheral 50 is operating, the power sharing circuit 56 is configured to use power from the external power interface 52, the local power supply 54, or from a combination of both sources. For example, the power sharing circuit 56 can direct that the load circuitry 60 first consume power from the computer bus 20 (through the external power interface 52), then, as the power requirements of the load circuitry 60 increase, power from the local power supply 54 is added to the power from the external power interface, and both provide power to the load circuitry 60.

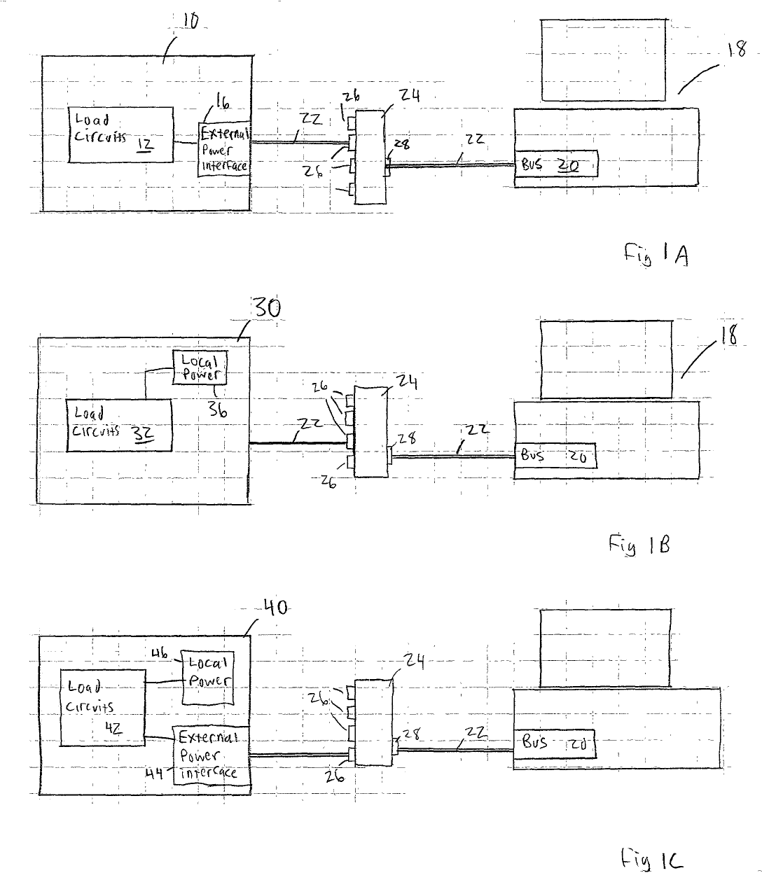

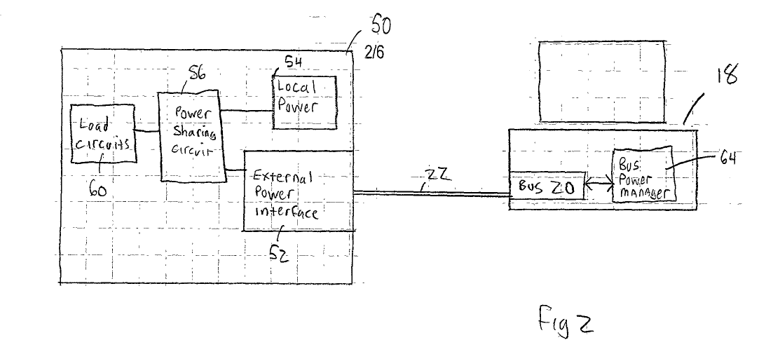

One of the reasons for sharing power usage in the peripheral device between two sources, e.g., the external power interface 52, and the local power supply 54, is that the local power supply can be made smaller than would be required if power from the bus 20 were not used. For instance, if the load circuitry 60 consumes 130 mA of peak current, and 90 mA can be provided by the external power interface 52, then the local power supply 54 need only be designed to supply a peak of 40 mA of current. If instead, the peripheral 50 were similar to that of the peripheral 40 of FIG. 1C, where the local power supply 46 must occasionally power the entire load circuitry 42 on its own, then the local power supply 54 of the peripheral 50 would need to be designed to supply all 130 mA of current, resulting in a much larger local power supply 54.

The power sharing circuit 56 of FIG. 2 can be designed to implement a number of functions. One example would be to equally share power between the local power supply 54 and the external power interface 52. But because power from the computer bus 20 is essentially “free” in that it is supplied by the computer 18, some embodiments of the invention are designed to utilize as much power as possible from the computer bus 20, before supplementing the power needs of the peripheral 50 by the local power supply 54.

In one embodiment, the power sharing circuit 56 uses 100% of the power required to drive the peripheral 50, up to a first threshold limit of the power consumed from the computer bus 20. Some busses, the USB for example, have limits on the amount of power that can be consumed by a peripheral device. The USB actually has two such limits, a low current limit of 100 mA, and a high current limit of 500 mA. The low current limit is automatic in that any peripheral device that connects to the computer bus 20 can use up to 100 mA, as long as the USB is not in a suspended state, discussed below. The high current limit is permissive, where a peripheral device can freely use up to 100 mA of current from the computer bus 20, but has to seek permission from a bus power controller 64 to use between 100 mA and 500 mA. The bus power controller 64, which is attached to the computer bus 20, manages the power functions of the computer bus. If there are too many other devices already connected to the computer bus 20 or the other connected devices are consuming too much power, the bus controller 64 will refuse permission for other high power peripheral devices to connect to the computer bus. Therefore, an embodiment of the power sharing circuit 56 draws the first 100 mA needed by a peripheral device from the computer bus 20, and supplies any additional power needs of the peripheral device above 100 mA from the local power supply 54.

FIG. 3 is a block circuit diagram showing details of the power sharing circuit 56 of FIG. 2. In that figure, the bus power controller 64 is coupled to the power lines of the bus cable 22 and regulates the power on those lines. The bus cable 22 is coupled to the external power interface 52 that is present in the peripheral device to be powered. Additionally coupled to the power sharing circuit 56 is the local power circuit 54. An output of the power sharing circuit 56 is coupled to the load circuitry 60 of the peripheral device being powered.

Depending on the type of computer bus 20 the power sharing circuit 56 is coupled to, the power sharing circuit may include a suspend circuit 72. The suspend circuit 72 disconnects the power sharing circuit 56 from the external power interface 52 when it receives a signal from the bus power controller 64 indicating that the computer bus 20 is entering a “suspend mode.” When a suspend mode is necessary, each peripheral connected to the computer bus 20 can only draw 500 uA (micro amps) or less of current. An example embodiment of the suspend circuit 72 is shown in FIG. 4, although it could be implemented in a variety of ways. FIG. 4 shows a resistor 74 coupled between the computer bus 20 and an IC control circuit 76. The IC control circuit 76 scans the bus cable 22 for a signal from the bus power manager 64 indicating that the computer bus 20 is entering the suspend mode. When the IC control circuit 76 detects the suspend mode signal, the control circuit drives a control terminal of a transistor 78 to turn off the transistor. For example, if the transistor 78 is a PMOS transistor, the IC control circuit 76 drives a control gate with a HIGH signal, which turns off the PMOS transistor, and in turn detaches the computer bus 20 from the rest of the power sharing circuit 56. In normal operation, when the computer bus 20 is not operating in the suspend mode, the IC control circuit 76 drives the gate of the transistor 78 with a LOW signal, which couples the computer bus 20 to the power sharing circuit 56.

Returning back to FIG. 3, the suspend circuit 72 is coupled to a regulator circuit 80, which is located between the suspend circuit 72 and the load circuitry 60. The regulator circuit 80 allows the load circuitry 60 to use power from the computer bus 20 until a specific current level is being drawn from the computer bus 20, and, for current needs that are above that level, the regulator 80 allows the local power supply 54 to supplement the power needs of the load circuitry.

One way to structure the regulator circuit 80 is to configure it as a shunt regulator, with a resistor 82 in series with the computer bus 20, and a zener diode 84 coupled in parallel with the load, which in this case is the load circuitry 60. The zener diode 84 is structured to operate in its reverse breakdown region at the normal current operating levels of the computer bus 20 to perform the shunting operation.

In operation, as the current level used by the load circuitry 60 increases, a voltage drop across the resistor 82 also increases, reducing the operating voltage of the power supplied by the computer bus 20. When the operating voltage is reduced so much that it matches a voltage level that is output by the local power supply 54, current begins to flow from the local power supply to the load circuitry 60 in addition to that flowing from the computer bus 20. As the load circuitry 60 requires even more current, it is provided by the local power supply 54, and not from the computer bus 20. A current blocking diode 86 is placed in line with the power from the computer bus 20 and between the regulator circuit 80 and the local power supply 54, to avoid current being pulled from the local power supply 54 into the computer bus 20 itself.

FIG. 5 shows another way to implement the power sharing circuit 56. In that figure a voltage regulator 90 has an input from the computer bus 20, and an output terminal where a voltage limited power signal is produced. The suspend circuit 72 drives a control input of the voltage regulator 90 so that when the computer bus 20 is not in the suspend state, the voltage regulator 90 limits the input voltage to a desired output voltage, e.g., 3.6 volts. When the computer bus 20 is in the suspend state, the suspend circuit causes the voltage regulator 90 to produce no output, thus cutting it off from the load circuitry 60. The voltage regulated output is coupled to a resistor 92, which has a function similar to the resistor 82 of FIG. 3 in that, when a certain amount of current drawn from the computer bus 20 is exceeded, the resistor 92 causes the voltage to drop on the power supplied by the computer bus. Once the voltage output from the voltage regulator 90 is reduced by the amount of voltage drop of the resistor 92 to match the output of the local power circuit 54, then the local power circuit begins supplying additional power to the load circuitry 60.

By properly tuning the regulator circuit 80 of FIG. 3, the voltage regulator 90 and resisters 92 of FIG. 5, and the local power supply 54, the power sharing circuit 56 can be controlled to begin using current from the local power supply 54 after any desired amount of current has been drawn from the computer bus 20. For instance, if the computer bus 20 supplies 5 volts dc, by using a twelve ohm resister for the resistor 82 in FIG. 3, and a 3.9 volt, 500 mW zener diode 84, the power sharing circuit 56 will start using power from a 3.0 volt local power supply 54 once about 90 mA of current has been supplied by the computer bus 20. Or, by using a 3.6 volt voltage regulator 90 and a 6.2 ohm resistor 92 in the power sharing circuit 56 shown in FIG. 5, again, the power sharing circuit will begin to draw power from a 3.0 volt local power supply 54 after using about 90 mA from the computer bus 22. Of course, any desired level of current sharing can be set by choosing appropriate values in the power sharing circuit 56, and can be implemented by one having skill in the art without undue experimentation.

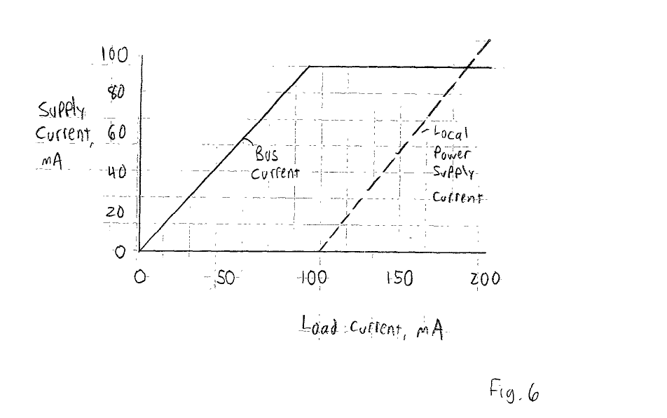

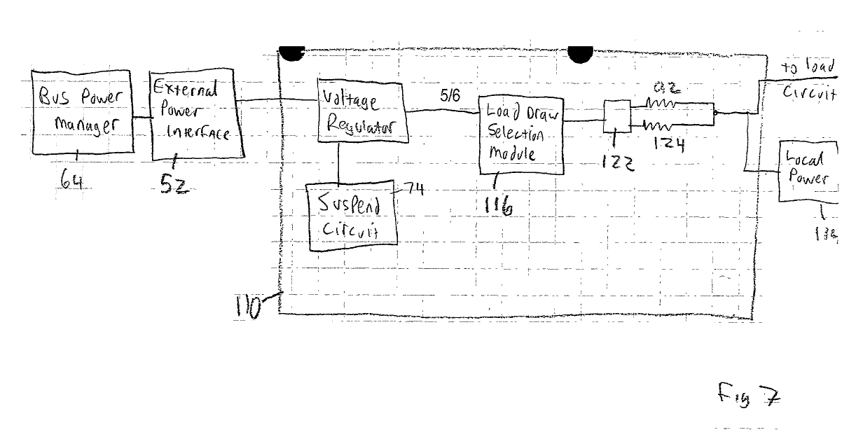

FIG. 6 is a graph showing the source of power used by the load circuit 60 in the peripheral device 50 configured with a power sharing circuit 56 as in FIGS. 3 and 5. Prior to the time the load current of the load circuit 60 draws about 80 or 90 mA, 100% of the power is provided by the computer bus 20, and the local power supply 54 provides no current for the load circuit. Once the load circuit 60 is drawing more than about 90 mA from the computer bus 20, all of the additional current consumed by the load circuit 60 is provided by the local power supply 54. The total current consumed by the load circuitry 60 is shown on the x-axis.

Another embodiment of the power sharing circuit requires more circuitry to implement than the previously described embodiments, but provides more functionality to a peripheral device. In that embodiment, illustrated in FIG. 7, a power sharing circuit 110 draws about 100 mA of current from the computer bus 20, and any additional power needs are temporarily supplied by a local power supply 114. The power sharing circuit then negotiates with the computer bus 20 to join the bus as a high power device, i.e., to be able to draw more than 100 mA of current. Once permission is given by the bus power manager 64 to join as a high power device, the power sharing circuit 110 changes to draw up to 500 mA from the computer bus 20. If the peripheral uses less than 500 mA, as most computer peripherals do, then all of the power for the peripheral device is supplied by the computer bus 20.

In the embodiment shown in FIG. 7, the computer bus 20 supplies up to the first 100 mA of power needed by a peripheral device, then temporarily uses the local power supply 114 for any excess power needs above that limit. During this time, the current from the computer bus 20 flows through the resistor 92 in the same way as it did in FIG. 3, which limits the power drawn from the computer bus 20 to about 100 mA.

During the temporary time that the local power supply is providing current in excess of 100 mA, a load draw selection module 116 communicates with the bus power controller 64 on the computer bus 20 to connect a peripheral device to the bus as a high power device, i.e., one that can draw up to 500 mA of current from the computer bus. If the bus power controller 64 grants access for the peripheral to connect to the computer bus 20 as a high power device, then a switching circuit 122 changes the power flow in the power sharing circuit 110 to flow through another resistor 124, which takes the place of the resistor 92 when directed by the load draw selection module 116. When the power sharing circuit 110 is in the configuration where current from the computer bus 20 flows through the resistor 124 instead of the resistor 92, then up to 500 mA of current can be drawn from the computer bus 20 before the local power supply 114 provides any current. Of course, if a peripheral device requires more than 500 mA of current, the local power supply 114 will provide all of the current in excess of 500 mA, because, at least for the USB, no single device can draw more than 500 mA of current from the computer bus 20.

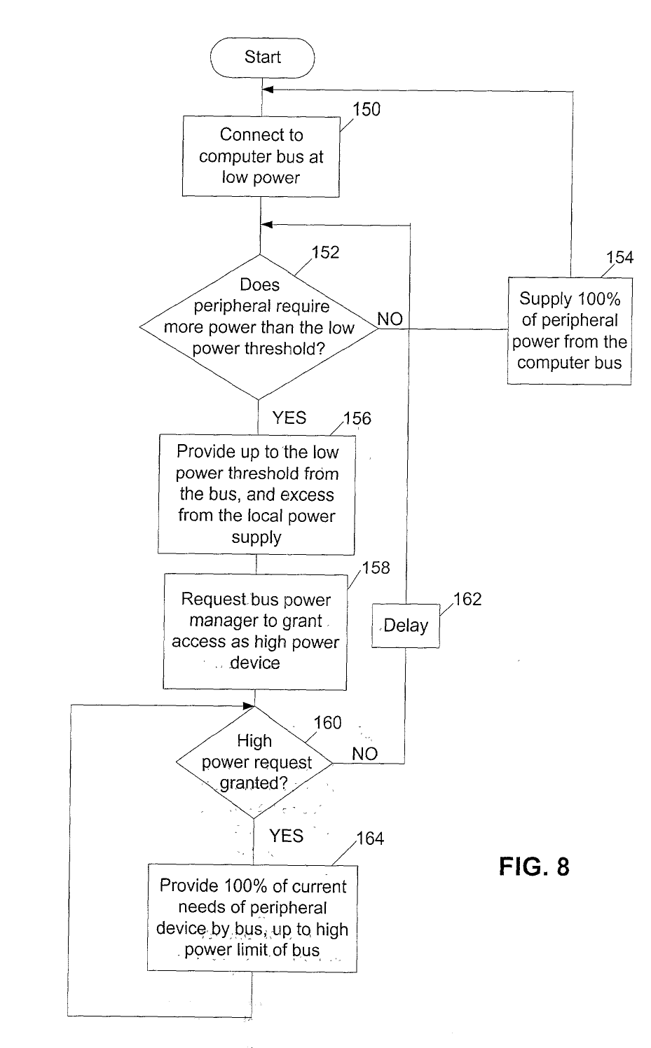

FIG. 8 is an example flow diagram showing processes the power sharing circuit 110 can use in operation. For this example, assume that a peripheral device consumes up to 350 mA of current. The flow begins at step 150, where the peripheral device connects to the computer bus 20 in the low power mode (under 100 mA). A query is performed at step 152 to determine if the peripheral device requires more power than the low current limit of the computer bus 20. If not, then in step 154 the computer bus 20 supplies all of the power necessary for the peripheral device, and the flow loops back again to constantly monitor the power needs of the peripheral device. Instead, if the peripheral device does require more than the low current threshold of the computer bus 20, then step 156 provides up to the low current limit of the computer bus from the bus, and temporarily provides the additional current from the local power supply 114. In this example, step 156 provides 100 mA of current from the computer bus 20, and 250 mA of current from the local power supply 114.

The flow then proceeds to step 158, which makes a request to the bus power manager 64 to connect the peripheral to the computer bus 20 as a high power device. If the bus power manager 64 signals that the peripheral device cannot presently join the bus as a high power device in a step 160, then the flow waits for a time in a delay step 162, and loops back to step 152 to continue checking to see if either the power requirements of the peripheral device have changed, or if the bus manager 64 will allow the device to join the bus as a high power device.

If the bus power manager 64 allows the peripheral device to join as a high power device, then in step 164 the power sharing circuit 110 changes internally to allow 500 mA of current to be drawn from the computer bus 20 before supplementing any current needs of the peripheral device from the local power supply 114. In this example, the power sharing circuit 110 would provide all 350 mA from the computer bus 20 to the peripheral device, after being given permission to join the bus as a high power device.

The flow then loops back to step 160 to monitor the bus power manager 64 to constantly check to determine if, for some reason, the bus power manager needs to disconnect the peripheral device 120 as a high power device, and instead only allow it to draw 100 mA of power from the bus. In such a case, the flow exits step 160 in the negative, and proceeds through the flow back to step 156 where the computer bus only provides 100 mA of current and the local power supply supplies the difference.

Using shared power to drive peripheral devices, i.e., using up to 90 mA or up to 500 mA of current from the computer bus 20 and providing the rest of the necessary power from a local power supply 54 has advantages over present methods of providing power in peripheral devices. One advantage is that less battery or other power from the local power supply is consumed by the peripheral device. This can save a user from excessive and unnecessary battery changes. Another advantage is that using only 90 or 100 mA of current from the computer bus 20 may change the classification of the peripheral device from a high power device (one that normally uses over 100 mA of current) to a low power device (one that uses under 100 mA) of current by combining power from both the computer bus and the local power supply. Because, for some types of computer busses, low power devices are allowed to join the computer bus at all times that the bus is operative, and high power devices must receive permission to join the bus, by sharing power between the bus and the local power supply, the peripheral device is nearly always assured that it can join the bus at any time. A related benefit stems from the rule that sometimes high power peripheral devices are not allowed to join the computer bus if they are coupled directly to a non-powered hub 24, i.e., one that does not have its own power supply. If, by sharing power, a peripheral device is reclassified from a high power device to a low power device, then the peripheral device could couple to any type of hub 24, including the powered and non-powered types. A further advantage to embodiments of the invention is that the local power supply circuitry can be made smaller than is otherwise necessary, because up to 100 mA or 500 mA of current can be drawn from the computer bus 20 and therefore does not need to be generated by the local power supply within the peripheral device. Even further consideration is that any “low power until configured” requirement (when the device must attach at less than 100 mA and seek permission to attach at between 100 mA and 500 mA) circuitry may be eliminated in some embodiments, thus making the peripheral device less costly to implement.

Implementation of the power sharing system is straightforward and intuitive once the details of the invention as described above are known. As always, implementation of the invention is left to the system designer. The circuits may be implemented in any way, with any components as long as they can perform the necessary functions.

Thus, although particular embodiments for a power sharing system in a peripheral device have been discussed, it is not intended that such specific references be considered as limitations upon the scope of this invention, but rather the scope is determined by the following claims and their equivalents.

What is claimed is:

1. A system for sharing power in a computer peripheral device, comprising:
a local power supply;
a power supply interface adapted to receive an external power source; and
a power sharing circuit coupled to the local power supply and to the power supply interface, the power sharing circuit structured to simultaneously provide power to the peripheral device from both the local power supply and from the external power source.

2. The system according to claim 1, wherein when an amount of power required by the peripheral device is below a power threshold, the power sharing circuit is structured to provide power to the peripheral device from either the local power supply or from the external power supply.

3. The system according to claim 2, wherein the power sharing circuit is structured to provide power to the peripheral device from the external power supply when the amount of power required by the peripheral device is below the power threshold.

4. The system according to claim 2 wherein the power threshold is 100 mA.

5. The system according to claim 1, wherein the power sharing circuit comprises:
a resistive device coupled in series between the power supply interface and a load; and
a zener diode coupled to the resistive device.

6. The system according to claim 5, further comprising a suspend circuit coupled between the external power source and the load, the suspend circuit structured to disconnect the load from the external power source responsive to a signal from the power source.

7. The system according to claim 1, wherein the power sharing circuit comprises:
a voltage regulator coupled in series between the power supply interface and a load; and
a resistive device coupled in series between the voltage regulator and the load.

8. The system according to claim 7, further comprising a suspend circuit coupled between the external power source and the load, the suspend circuit structured to disconnect the load from the external power source responsive to a signal from the power source.

9. The system according to claim 1, wherein the external power source is a computer bus.

10. The system according to claim 9, wherein the computer bus is a Universal Serial Bus.

11. The system according to claim 1 wherein the local power supply comprises batteries.

12. A peripheral device comprising:
a load circuit for consuming power in the peripheral device;
a local power source for providing power in the peripheral device;
a power source interface adapted to receive an external power source; and
a power sharing circuit coupled to the local power supply and to the power supply interface, the power sharing circuit structured to provide power to the load circuit from both the local power source and from the external power source at the same time.

13. The system according to claim 12, wherein when an amount of power required by the load circuit is below a power threshold, the power sharing circuit is structured to provide power to the peripheral device from either the local power source or from the external power source.

14. The system according to claim 12, wherein when an amount of power required by the load circuit is below a power threshold, the power sharing circuit is structured to provide power to the peripheral device from the external power source.

15. The system according to claim 12, wherein when an amount of power required by the load circuit is above a first power threshold, but below a second power threshold, the power sharing circuit is structured to provide power to the peripheral device from either the external power supply, or from a combination of the external power supply and the local power supply.

16. The system according to claim 12, wherein the power sharing circuit comprises:
a resistive device coupled in series between the power supply interface and the load circuit; and
a zener diode coupled to the resistive device and configured as a shunt regulator.

17. The system according to claim 12, wherein the power sharing circuit comprises:
a voltage regulator coupled in series between the power supply interface and the load circuit; and
a resistive device coupled in series between the voltage regulator and the load circuit.

18. The system according to claim 12, wherein the external power source is a computer bus and is coupled to the power sharing circuit via a bus cable.

19. The system according to claim 18, wherein the computer bus is a Universal Serial Bus.

20. A method for providing power to a load circuit in a computer peripheral device, comprising:
providing from a power source external to the peripheral device power requirements of the load circuit up to a threshold amount of power; and
providing from a combination of the external power source and from a power source internal to the peripheral device the power requirements of the load circuit if the power requirements of the load circuit exceed the threshold amount.

21. The method of claim 20, wherein providing power requirements from the external power source comprises providing power from a computer bus.

22. The method of claim 21 wherein providing power requirements from a computer bus comprises providing power from a Universal Serial Bus.

23. The method of claim 20, further comprising requesting the external power source to provide all the power requirements of the load circuit above the threshold amount.

24. The method of claim 23, wherein requesting the external power source to provide all the power requirements of the load circuit comprises sending a signal to a bus power manager.

25. A method for providing power to a load circuit in a computer peripheral device, comprising:
providing an initial amount of power to the load circuit from an external source;
allowing the load circuit to increase the amount of power drawn from the external source;
monitoring the amount of power drawn from the external source; and
adding power from a local power source to the amount of power drawn from the external source once the amount of power drawn from the external source exceeds a threshold level.

26. The method of claim 25, wherein providing power from an external source comprises providing power from a computer bus.

27. The method of claim 26 wherein providing power from a computer bus comprises coupling the peripheral device to a Universal Serial Bus.

28. The method of claim 25, further comprising requesting the external source to provide all the power used by the load circuit if the amount of power drawn from the external source exceeds the threshold level.
